(19) United States
(12) Patent Application Publication
(10) Pub. No.: US 2026/0136266 A1
(43) Pub. Date: May 14, 2026

(54) EMERGENCY MESSAGE LOCATION DETERMINATION FOR NON-TERRESTRIAL NETWORKS

(71) Applicant: DISH Wireless L.L.C., Englewood, CO (US)

(72) Inventors: Raghavendhra Rao, Littleton, CO (US); Mehdi Alasti, Herndon, VA (US); Adam Bensaid, Parker, CO (US)

(21) Appl. No.: 18/946,575

(22) Filed: Nov. 13, 2024

(51) Int. Cl. H04W 40/02; H04W 4/029; H04W 4/90; H04W 84/06

(52) U.S. Cl. CPC H04W 40/02; H04W 4/029; H04W 4/90; H04W 84/06

(57) ABSTRACT

Systems and methods for modifying emergency messages received by a non-terrestrial network satellite to include information for identifying emergency services to respond to the emergency messages. A total geographical coverage area for the emergency services is divided into one or more emergency zones for non-terrestrial network emergency communications. Each corresponding emergency zone is assigned a unique identifier. When an emergency message is received from a user device via the non-terrestrial network satellite, an emergency zone that corresponds to the geographical location of the user device is determined, along with the unique identifier assigned to that emergency zone. The emergency message is then modified to include that unique identifier, and the modified emergency message is output for the emergency services.

### BACKGROUND

Mobile phones are being used more and more by more and more people. As the use of mobile phones has increased, so too has the need to make 911 calls from mobile phones. Emergencies, however, can occur anywhere at any time, regardless of whether the mobile phone has a connection to a terrestrial network or a connection to a non-terrestrial network satellite. The speed at which emergency services can respond to a 911 call relies on selecting the appropriate emergency services based on the caller's location. Unfortunately, selecting the appropriate emergency services can be difficult when the 911 call is made through a non-terrestrial network satellite, especially when the 911 call is a text-based message. It is with respect to these and other considerations that the embodiments described herein have been made.

### BRIEF SUMMARY

Embodiments are directed towards systems and methods for dynamically modifying emergency messages transmitted from a user device via a non-terrestrial network satellite to include a unique identifier for a PSAP zone in which the user device is located. Mappings between PSAP zones and their correspondingly assigned unique identifiers are generated and stored for use when an emergency message is received. To generate the mappings, a total geographical coverage area for a public safety answering point (PSAP) is determined. That total geographical coverage area for the PSAP is divided into one or more PSAP zones for non-terrestrial network emergency communications. A unique identifier is assigned to each corresponding PSAP zone of the one or more PSAP zones, which can then be stored in the mappings. When an emergency message is received from a user device via a non-terrestrial network satellite, the geographical location of the user device is determined. The PSAP zone and its assigned unique identifier are then determined based on the geographical location of the user device. The emergency message is modified to include the unique identifier for that PSAP zone. The modified emergency message is then output to another system, which can select the appropriate PSAP and forward the modified emergency message to that PSAP.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings.

FIG. 1 illustrates a context diagram of an environment for modifying emergency messages received via a non-terrestrial network satellite based on the location of the user device sending the emergency messages in accordance with embodiments described herein.

FIGS. 2A-2B illustrate context diagrams for selecting emergency services for emergency messages received via a terrestrial network cell.

FIG. 3 illustrates a context diagram for selecting emergency services for emergency messages received via a non-terrestrial network satellite in accordance with embodiments described herein.

FIG. 4 illustrates a context diagram of an architecture for transmitting emergency messages via a non-terrestrial network satellite in accordance with embodiments described herein.

FIG. 5 illustrates a logical flow diagram showing one embodiment of a process for generating a mapping between geographical emergency service zones and assigned unique identifiers for emergency service communications via a non-terrestrial network satellite in accordance with embodiments described herein.

FIG. 6 illustrates a logical flow diagram showing one embodiment of a process for modifying an emergency message received via a non-terrestrial network satellite based on the mapping between geographical emergency service zones and assigned unique identifiers in accordance with embodiments described herein.

FIG. 7 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

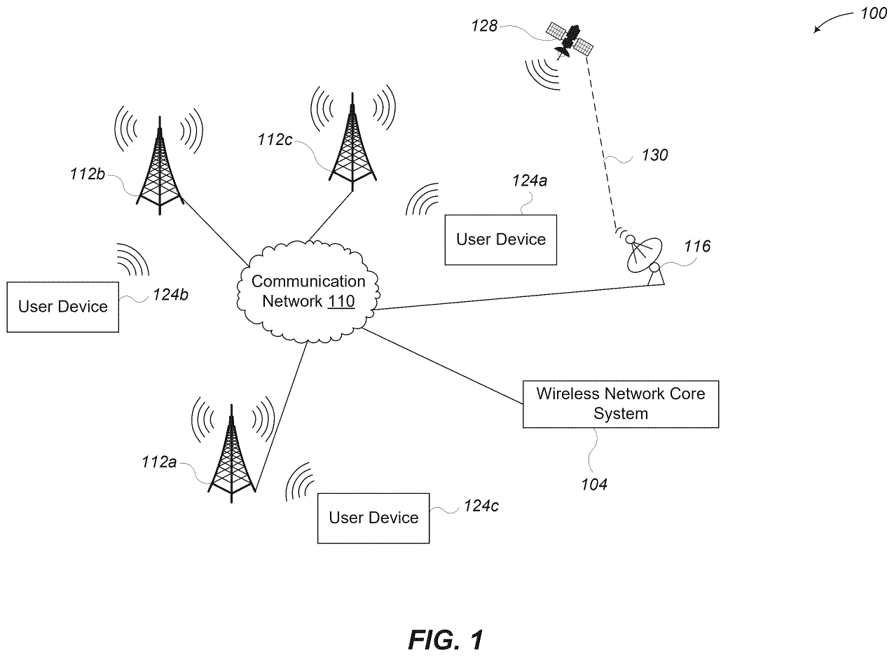

FIG. 1 illustrates a context diagram of an environment 100 for modifying emergency messages received via a non-terrestrial network satellite based on the location of the user device sending the emergency messages in accordance with embodiments described herein. Environment 100 includes a plurality of terrestrial network cells 112a-112c, a non-terrestrial network satellite 128, a plurality of user devices 124a-124c, feeder-link system 116, and a wireless network core system 104, which may be in communication via a communication network 110. Communication network 110 includes one or more wired or wireless networks, which may include a series of smaller or private connected networks that carry information between the terrestrial network cells 112a-112c, feeder-link system 116, and the wireless network core system 104.

The user devices 124a-124c are computing devices that receive and transmit cellular communication messages or data with the terrestrial network cells 112a-112c or the non-terrestrial network satellite 128. The user devices 112a-112c may include any combination of user devices that are configured to communicate with only terrestrial network cells 112a-112c, are configured to communicate with only non-terrestrial network satellite 128, or are configured to communicate with both the terrestrial network cells 112a-112c and the non-terrestrial network satellite 128. Examples of user devices 124a-124c may include, but are not limited to, mobile devices, smartphones, tablets, cellular-enabled laptop computers, very small aperture terminals (VSAT), Earth station in motion (ESIM), or other computing devices that can communication with a cellular network. User devices 124a-124c that are connected to or in communication with a terrestrial network cell 112 may be referred to as terrestrial user devices, and user devices 124a-124c that are connected to or in communication with a non-terrestrial network satellite 128 may be referred to as non-terrestrial user devices. Although FIG. 1 shows three user devices 124a-124c, embodiments are not so limited. Rather, one user device or a plurality of user devices may be employed.

The terrestrial network and the non-terrestrial network supported by the terrestrial network cells 112a-112c and the non-terrestrial network satellite 128 may be collectively referred to as a cellular communications network (also referred to as a wireless network), e.g., a 5G cellular communications network. Although embodiments are described herein with the terrestrial network and the non-terrestrial network being part of a collective cellular network, embodiments are not so limited. Embodiments described herein may also be employed in environments where the terrestrial network and the non-terrestrial network are separate, independent networks.

The terrestrial network cells 112a-112c are ground-based cellular towers that together provide the hardware infrastructure of a terrestrial network or a terrestrial cellular communications network. The terrestrial network cells 112a-112c may be individually referred to as a terrestrial network cell 112 or collectively referred to as terrestrial network cells 112.

The non-terrestrial network satellite 128 is a satellite-based cellular system or satellite that provides the hardware infrastructure of a non-terrestrial network or a non-terrestrial cellular communications network. In some embodiments or situations, the non-terrestrial network satellite 128 may also be referred to as a non-terrestrial network cell or as a non-terrestrial network payload depending on the architecture, configuration, or deployment of the non-terrestrial network. In some embodiments, a non-terrestrial network in 3GPP may refer to or include geostationary (GEO) satellites, low Earth orbit (LEO) satellites, or medium Earth orbit (MEO) satellites, or high-altitude platform stations (HAPS). User devices 124a-124c may be configured to transmit and receive wireless communications to and from the non-terrestrial network satellite 128. The non-terrestrial network satellite 128 can transmit and receive such communications via a bi-directional feeder-link 130 with the feeder-link system 116, which is connected to the rest of the wireless network.

The terrestrial network cells 112a-112c and the non-terrestrial network satellite 128 may include or be in communication with base stations, radio back-haul equipment, antennas, or other devices, which are not illustrated for ease of discussion. Although FIG. 1 shows three terrestrial network cells 112a-112c, embodiments are not so limited. Rather, one terrestrial network cell or a plurality of terrestrial network cells may be employed. Similarly, although FIG. 1 shows one non-terrestrial network satellite 128, embodiments are not so limited. Rather, one non-terrestrial network satellite or a plurality of non-terrestrial network satellites may be employed.

Terrestrial network cells 112 and the non-terrestrial network satellite 128 provide compatible cellular communications over a coverage area. The coverage area of each terrestrial network cell 112 may vary depending on the elevation antenna of the terrestrial network cell, the height of the antenna of the terrestrial network cell above the ground, the electrical tilt of the antenna, the transmit power utilized by the terrestrial network cell, the operating spectrum of the cell, or other capabilities that can be different from one type of terrestrial network cell to another or from one type of hardware to another. Likewise, the coverage area of the non-terrestrial network satellite 128 may vary depending on the orbit or position of the non-terrestrial network satellite, the elevation angle of the non-terrestrial network satellite, the transmit power utilized by the non-terrestrial network satellite, or other hardware capabilities of the non-terrestrial network satellite. The overall capacity of the terrestrial network created by the terrestrial network cells 112a-112c and the non-terrestrial network created by the non-terrestrial network satellite 128 depends on the coverage of each cell and the interference that the cells may have on each other.

In various embodiments, a group of terrestrial network cells 112a-112c that make up the cellular communication network may be referred to as a “market.” A market may be for a particular city, neighborhood, geographical area, or other selected or specified cluster of cells. Similarly, a non-terrestrial network satellite 128 may have a coverage area that includes one or more markets of terrestrial network cells, and in many situations, the coverage area of the non-terrestrial network satellite 128 is much larger than a particular market for a group of terrestrial network cells. In situations where the coverage area of a terrestrial network cell overlaps (or borders) the coverage area of a non-terrestrial network satellite, the various techniques described herein may be employed to mitigate interference between the cells.

As described herein, the non-terrestrial network satellite 128, the feeder-link system 116, or the wireless network core system 104 are configured to generate mappings between PSAP zones for a plurality of PSAPs (and their corresponding PSAP coverage areas) and unique identifiers. The non-terrestrial network satellite 128, the feeder-link system 116, or the wireless network core system 104 can then use these mappings to modified emergency messages transmitted by user devices 124a-124c and received by the non-terrestrial network satellite 128, as described herein, so that the emergency message includes a unique identifier of a PSAP zone in which the user device that transmitted the emergency message is located. This unique identifier can then be used by an emergency control center (which may be referred to as a text control center) to select the appropriate PSAP for the emergency message. In embodiments, the user device itself may be enabled to include the geographical location of the user device or even the corresponding PSAP zone's unique identifier in the emergency message.

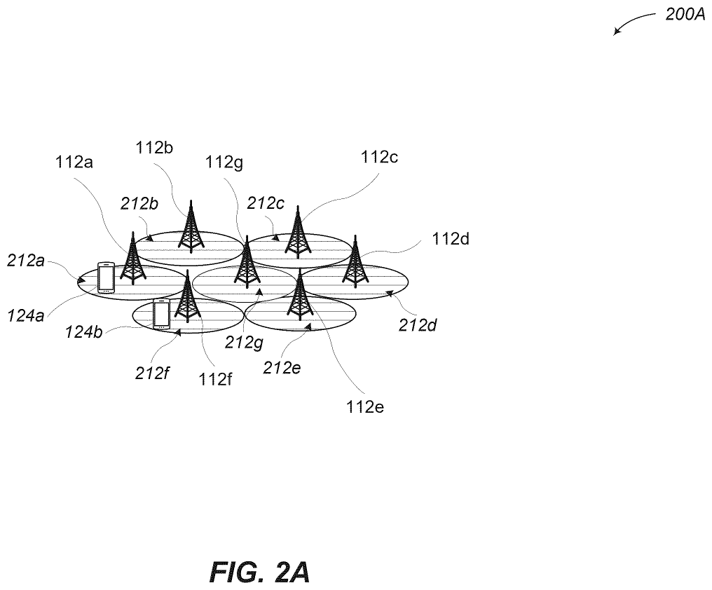

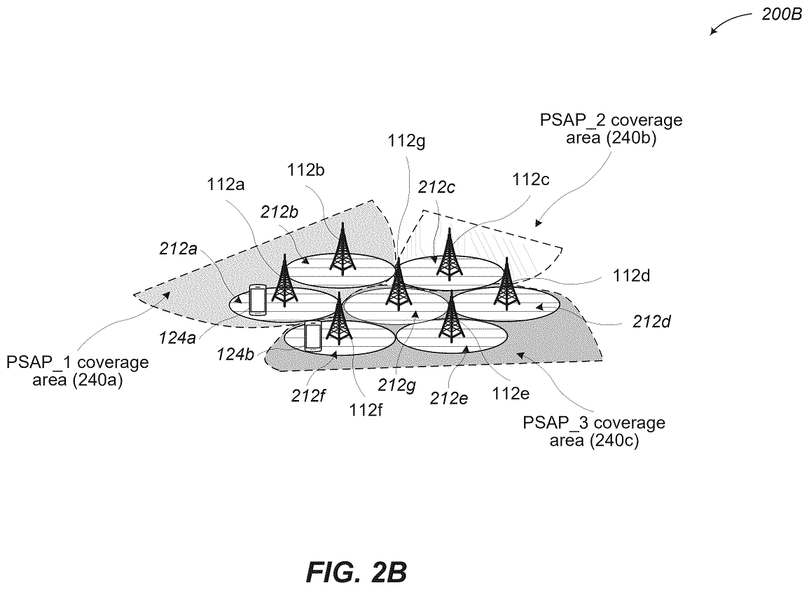

FIGS. 2A-2B illustrate context diagrams for selecting emergency services for emergency messages received via a terrestrial network cell. FIGS. 2A-2B are an example of a terrestrial network and how emergency services can be selected, which is to help illustrate the distinction of how emergency services are selected in a non-terrestrial network, as described herein. System 200A in FIG. 2A includes a plurality of terrestrial network cells 112a-112g. Each terrestrial network cell 112a-112g has a corresponding coverage area 212a-212g. The coverage areas 212a-212g are geographical areas in which user devices 224a-224b can wirelessly communicate with the terrestrial network cells 112a-112g. For example, user device 224a is in coverage area 212a and can communicate with terrestrial network cell 112ea, and user device 224b is in coverage area 212f and can communicate with terrestrial network cell 112f.

System 200B in FIG. 2B is similar to system 200A in FIG. 2A with terrestrial network cells 112a-112g and their corresponding coverage areas 212a-212g. In some situations, the terrestrial network cells 112a-112g are logically separated into separate PSAP coverage areas 240a-240c (also referred to as emergency service coverage areas). In this illustrative example, terrestrial network cells 112a and 112b are in PSAP coverage area 240a, terrestrial network cell 112c is in PSAP coverage area 240b, and terrestrial network cells 112d, 112e, 112f, and 112g are in PSAP coverage area 240c. Each PSAP coverage area is associated with a particular PSAP. For example, PSAP coverage areas 240a is associated with PSAP_1, PSAP coverage areas 240b is associated with PSAP_2, and PSAP coverage areas 240c is associated with PSAP_3.

Because terrestrial network cells have a relatively small geographical coverage area (compared to a non-terrestrial network satellite), those cells can be logically groups into specific PSAP coverage areas 230a-230c. Thus, if user device 224a makes an emergency call, which is received by terrestrial network cell 112a, then that emergency call is forwarded to the PSAP associated with PSAP coverage area 240a (i.e. PSAP_1). In comparison, if user device 224b makes an emergency call, then that emergency call is forwarded to the PSAP associated with PSAP coverage area 240c (i.e., PSAP_3).

But non-terrestrial network satellites can have a much larger coverage area that can include the coverage area of multiple PSAPs.

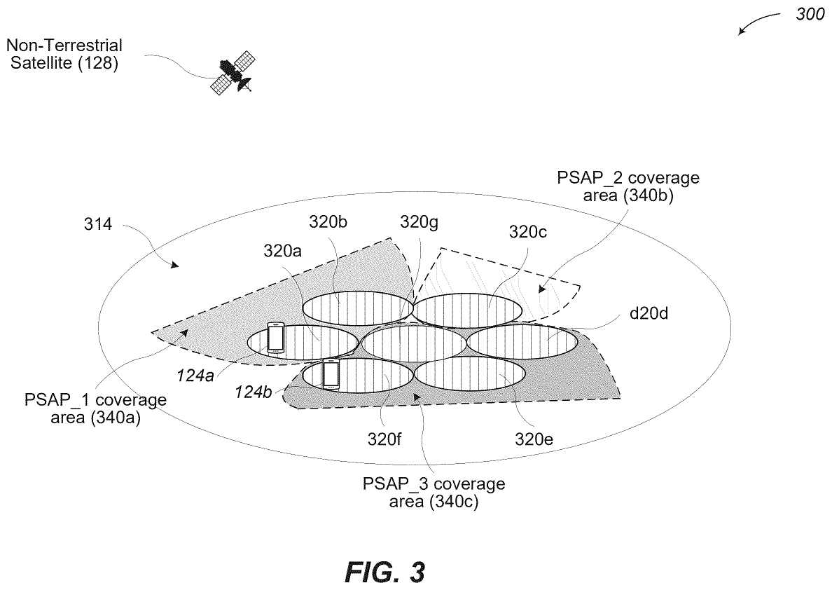

FIG. 3 illustrates a context diagram for selecting emergency services for emergency messages received via a non-terrestrial network satellite in accordance with embodiments described herein.

System 300 includes non-terrestrial network satellite 128, similar to what is discussed in FIG. 1. In this illustrative example, the coverage area 314 of the non-terrestrial network satellite 128 includes multiple PSAP coverage areas 340a-340c, where PSAP coverage areas 340a is associated with PSAP_1, PSAP coverage areas 340b is associated with PSAP_2, and PSAP coverage areas 340c is associated with PSAP_3. The use of PSAP_1, PSAP_2, and PSAP_3 in conjunction with FIG. 3 may refer to the same or different PSAPs described in conjunction with FIGS. 2A-2B.

When the non-terrestrial network satellite 128 receives an emergency message from user device 124a, it may be difficult for the network determine whether the user device 124a is in PSAP coverage area 340a for PSAP_1 or the user device 124a is in PSAP coverage area 340c for PSAP_3. Similarly, it may be difficult for the network determine whether user device 124b is in PSAP coverage area 340a for PSAP_1 or in PSAP coverage area 340c for PSAP_3 when the user device 124b sends an emergency message that is received by the non-terrestrial network satellite 128.

By employing embodiments described herein, each PSAP coverage area 340b is divided into one or more smaller, non-overlapping PSAP zones 320a-320g (also referred to as emergency service zones). In this illustrative example, PSAP coverage area 340a is divided into PSAP zones 320a-320b, PSAP coverage area 340b is divided into PSAP zone 320c, and PSAP coverage area 340c is divided into PSAP zones 320d-320g. Each PSAP zone 320a-320g is assigned a unique identifier.

When user device 124a transmits an emergency message that is received by the non-terrestrial network satellite 128, the network determines the geographic location of the user device 124a and determines that the user device 124a is in PSAP zone 320a. The network can then obtain the unique identifier assigned to PSAP zone 320a, such as by accessing a database that stores mappings between PSAP zones 320a-320g and their correspondingly assigned unique identifiers. The network then modifies the emergency message to include the unique identifier assigned to the PSAP zone 320a in which the user device 124a is located.

The unique identifier included in the modified emergency message can then be used by an emergency control center, to determine that the user device 124a is in PSAP coverage area 340a and then forward the emergency message to the associated PSAP_1. Including the unique identifier for the PSAP zone in which the user device is located can further enable the PSAP to dispatch the appropriate emergency services, such as dispatching a fire truck from a station located within PSAP zone 340a.

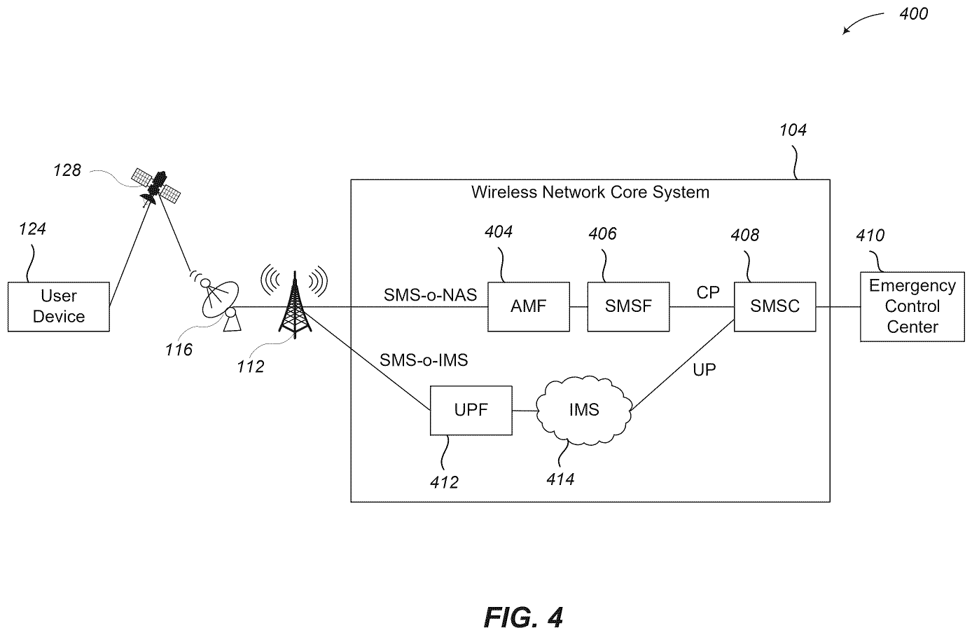

FIG. 4 illustrates a context diagram of an architecture 400 for transmitting emergency messages via a non-terrestrial network satellite in accordance with embodiments described herein. Architecture 400 includes user device 124, non-terrestrial network satellite 128, feeder-link system 116, terrestrial network cell 112, wireless network core system 104, and emergency control center 410.

As mentioned above, the user device 124 may transmit and receive communications, such as voice or text-based messages, with a wireless network via the non-terrestrial network satellite 128 and the feeder-link system 116. In some embodiments, the feeder-link system 116 may communicate with the wireless network core system 104 via a terrestrial network cell 112, as shown, or the feeder-link system 116 may communicate with the wireless network core system 104 without using a terrestrial network cell 112 (which is not shown). In general, when user device 124 transmits an emergency message to the non-terrestrial network satellite 128, the non-terrestrial network satellite 128 forwards the emergency message to the wireless network core system 104 via the feeder-link system 116 and the terrestrial network cell 112. The wireless network core system 104 processes the emergency message and transmits the emergency message to the emergency control center 410.

The emergency control center 410 may be configured as an emergency service provider that determines the location of the user device 124 that transmitted an emergency message, selects the appropriate or primary Public Safety Answering Point (PSAP) for that user device 124, and forwards the emergency message to the appropriate or primary PSAP.

In various embodiments, the wireless network core system 104, also referred to as the core network, may utilize a cloud-native service-based architecture in which different core network functions (e.g., authentication, security, session management, and core access and mobility functions) are virtualized and implemented as loosely coupled independent services that communicate with each other (e.g., using HTTP protocols and APIs). In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function that supports data storage for stateless network functions across the service-based architecture.

The core network functions performed by the wireless network core system 104 may include an access and mobility management Function (AMF) 404, Short Message Service Function (SMSF) 406, short message service center (SMSC) 408, user plane function (UPF) 412, and IP multimedia Subsystem (IMS) 414. The AMF 404, the SMSF 406, the SMSC 408, the UPF 412, and the IMS 414 are core network functions that collectively provide the support and functionality for the wireless network to enable and process communications transmitted within the network.

The AMF 404 may represent an access and mobility management function. The AMF 404 may act as a single-entry point for a user device connection and perform mobility management, registration management, and connection management between a data network and the user device 124. The SMSF 406 may conduct subscription checking and perform a relay function between the user device 124 and the SMSC 408 through interaction with the AMF 404. The UPF 412 may perform packet processing including routing and forwarding, quality of service (QoS) handling, and packet data unit (PDU) session management. The UPF 412 may serve as an ingress and egress point for user plane (UP) traffic and provide anchored mobility support for user devices. For example, the UPF 412 may provide an anchor point between the user device 124 and the data network as the user device moves between coverage areas within the network. The IMS 414 processes messages on the user plane from the UPF 412 to the SMSC 408. And the SMSC 408 is configured to forward messages, e.g., emergency messages, to recipients and to store SMS messages if the recipient is not immediately available. In the illustrative example, the SMSC 408 is configured to forward emergency messages to the TCC 410.

When an emergency message is received at the wireless network core system 104 from the user device 124, the emergency message is handled on the control plane as SMS over NAS (Non-Access Stratum) (also referred to as SMS-o-NAS) or on the user plane as SMS over IMS (also referred to as SMS-o-IMS).

In general, the SMS-o-NAS follows the signaling path via the AMF 404 using SRB (signaling radio bearers), which allows the emergency message to be anchored on the AMF 404 via the control plane. In some embodiments, the SMS message may be encapsulated in an NAS message. From the AMF 404, the emergency message is provided to the SMSF 406 and the SMSC 408. The SMSC 408 will then route the emergency message to the emergency control center 410. In SMS-o-NAS, the emergency message would be supported by the control plane location.

In comparison, the SMS-o-IMS would allow the emergency message to flow through the UPF 412 as normal traffic would be handled by the wireless network core system 104. In some embodiments, the SMS is encapsulated in a SIP message. From the UPF 412, the user plane sends the emergency message to the IMS 414, which then sends the emergency message via the user plane to the SMSC 408. Again, the SMSC 408 will route the emergency message to the emergency control center 410. In SMS-o-IMS, the emergency message can include the location of the user device 124 (as provided by the user device 124 or the PSAP zone determined as described herein) as part of the SIP header.

Whether the emergency message is an SMS-o-NAS or an SMS-o-IMS may depend on the capabilities of the user device 124, the location of the user device 124, or the capabilities of the non-terrestrial network satellite 128. By employing embodiments described herein, the non-terrestrial network satellite 128, the feeder-link system 116, or one or more components of the wireless network core system 104 may determine a PSAP zone in which the user device 124 is located such that the TCC 410 can select the appropriate PSAP for an emergency message sent by the user device 124.

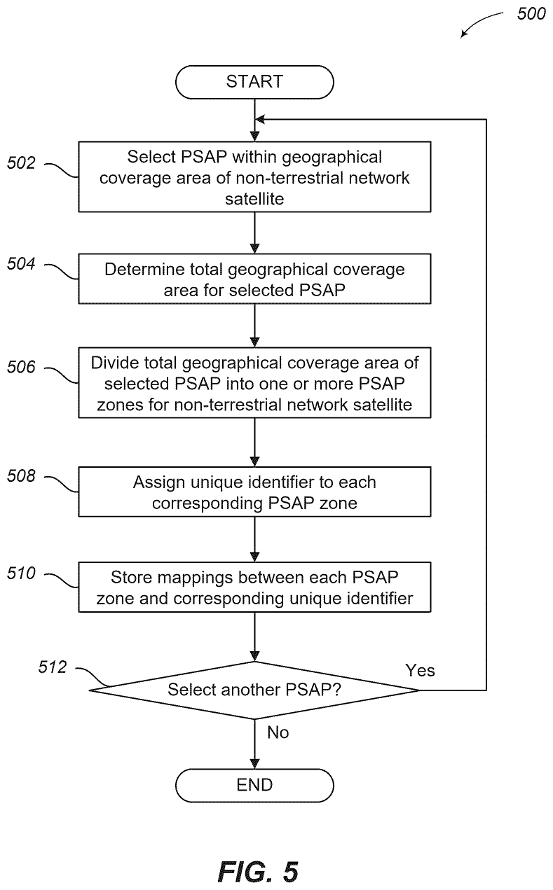

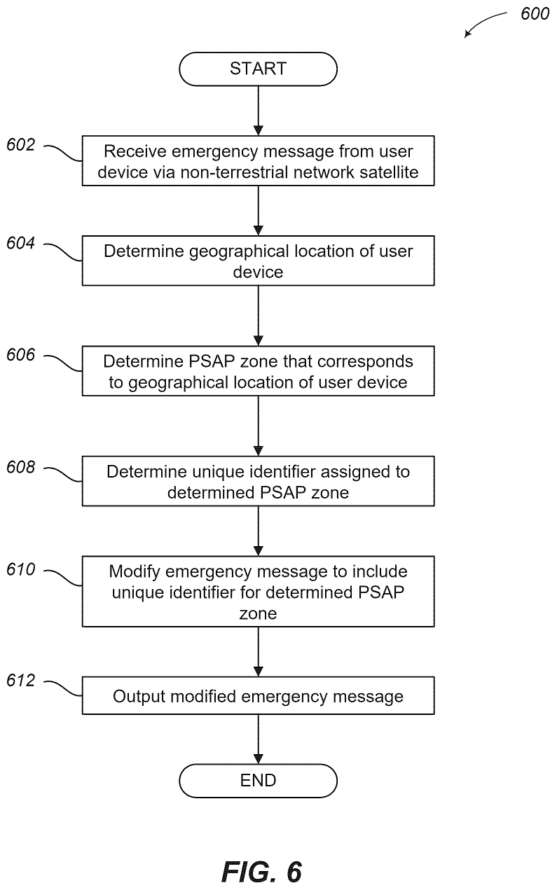

The operation of certain aspects will now be described with respect to FIGS. 5 and 6. Processes 500 and 600 described in conjunction with FIGS. 5 and 6, respectively, may be implemented by one or more processors or executed via circuitry on one or more computing devices, such as non-terrestrial network satellite 128, feeder-link system 116, wireless network core system 104, or some combination thereof.

FIG. 5 illustrates a logical flow diagram showing one embodiment of a process 500 for generating a mapping between geographical emergency service zones and assigned unique identifiers for emergency service communications via a non-terrestrial network satellite in accordance with embodiments described herein.

Process 500 begins, after a start block, at block 502, where a public safety answering point (PSAP) within the geographical coverage area of a non-terrestrial network satellite is selected. In various embodiments, the non-terrestrial network satellite may provide cellular communication connections for user devices within a geographical coverage area that includes a plurality of separate PSAPs. Each separate PSAP may be selected in a random or predetermined order.

Process 500 proceeds, after block 502, to block 504, where a total geographical coverage area is determined for the selected PSAP. In some embodiments, the total geographical coverage area of the selected PSAP is predefined or set by an administrator, which may be set by boundaries of towns, cities, counties, markets, or other geographical features.

Process 500 continues, after block 504, at block 506, where the total geographical coverage area of the selected PSAP is divided into one or more PSAP zones for the non-terrestrial network satellite. Each PSAP zone covers a geographical area of the selected PSAP, which does not overlap with another PSAP zone of the selected PSAP or of another PSAP. Accordingly, each PSAP zone includes a geographical boundary for a specific geographical area.

In some embodiments, the number of PSAP zones may vary depending on the geographical size or population of the selected PSAP. For example, the greater the geographical size of the total geographical coverage area of the selected PSAP, the greater the number of PSAP zones. In other embodiments, the number of PSAP zones may vary depending on the number of emergency response units or dispatch locations. For example, if the total geographical coverage area of the selected PSAP has five dispatch locations, then the total geographical coverage area of the selected PSAP may be divided into five PSAP zones, one for each dispatch location.

Process 500 proceeds, after block 506, to block 508, where a unique identifier is assigned to each corresponding PSAP zone for the selected PSAP. Each assigned identifier is unique compared to other identifiers assigned to PSAP zones for the selected PSAP and for other PSAPs. In this way, each PSAP zone for the plurality of PSAPs is assigned a unique identifier. In some embodiments, the unique identifier of a PSAP zone can be map to a geographical area defined by 3GPP as “mapped Cell-ID”.

Process 500 continues, after block 508, at block 510, where mappings between each PSAP zone and each corresponding unique identifier are stored. The mappings may include a pairing between the corresponding geographical area of a PSAP zone and its correspondingly assigned unique identifier.

Process 500 proceeds, after block 510, to decision block 512, where a determination is made whether another PSAP is selected. In some embodiments, each of a plurality of PSAPs within the coverage area of a non-terrestrial network satellite are selected so that each PSAP zone for the plurality of PSAPs are assigned and mapped to unique identifiers. If another PSAP is to be selected, process 500 loops to block 502; otherwise, process 500 terminates or otherwise returns to a calling process to perform other actions.

FIG. 6 illustrates a logical flow diagram showing one embodiment of a process 600 for modifying an emergency message received via a non-terrestrial network satellite based on the mapping between geographical emergency service zones and assigned unique identifiers in accordance with embodiments described herein.

Process 600 begins, after a start block, at block 602, where an emergency message is received from a user device via the non-terrestrial network satellite. As noted herein, the emergency message may be a text-based emergency message, a voice-based emergency call, or a real-time-text-based emergency message.

Process 600 proceeds, after block 602, to block 604, where a geographical location of the user device is determined. In various embodiments, the emergency message itself includes a geographical location of the user device. In other embodiments, the user device may be queried for its location. In some embodiments, the location of the user device may include: Global Navigation Satellite System (GNSS) data (e.g., Global Positioning System (GPS), GLONASS, BeiDou, Galileo, Indian Regional Navigation Satellite System (IRNSS), Quasi-Zenith Satellite System (QZSS), WiFi, Bluetooth Low Energy (BLE), other horizontal positional sensors (e.g., accelerometers or gyroscopes), or the like), cell or device triangulation, enhanced cell identification (e.g., a relative direction or distance from the location of the cell in which the user device is communicating), or other systems configured to capture a location of a user device providing the emergency message. In various embodiments, the location data may include horizontal location data, vertical location data, horizontal location uncertainty information, or vertical location uncertainty information, or some combination thereof.

Process 600 continues, after block 604, at block 606, where a PSAP zone that corresponds to the geographical location of the user device is determined. In at least one embodiment, the geographical location of the user device is compared to the boundaries of each of a plurality of PSAP zones to identify the PSAP zone in which the user device is located. If the geographical location of the user device is within the boundary of a specific PSAP zone, then that PSAP zone is determined as the PSAP zone that corresponds to the geographical location of the user device.

Process 600 proceeds, after block 606, to block 608, where a unique identified assigned to the determined PSAP zone is determined. In various embodiments, the mappings generated by process 500 in FIG. 5 are queried for the PSAP zone that corresponds to the geographical location of the user device and its correspondingly assigned unique identifier.

Process 600 continues, after block 608, at block 610, where the emergency message is modified to include the unique identifier determined at block 608. In some embodiments, the header of the emergency message is modified to include the unique identifier of the PSAP zone in which the user device is located. In other embodiments, a body of the message is modified to include the unique identifier of the PSAP zone in which the user device is located.

Process 600 proceeds, after block 610, to block 612, where the emergency message is output. In at least one embodiment, the modified emergency message is sent to an emergency control center, which can use the unique identifier in the modified message to determine which PSAP to associate with the emergency message. In this way, the emergency control center can select the appropriate PSAP that has jurisdiction for supporting emergency messages and calls from user devices in that same geographical area.

After block 612, process 600 terminates or otherwise returns to a calling process to perform other actions.

In some embodiments, the user devices themselves may store or have access to the mappings between the PSAP zones and their correspondingly assigned unique identifiers. In one such embodiment, the user device may employ process 600 to modify the emergency message with the unique identifier of the PSAP zone in which the user device is located, prior to transmitting the emergency message to a non-terrestrial network satellite, or even to a terrestrial network cell.

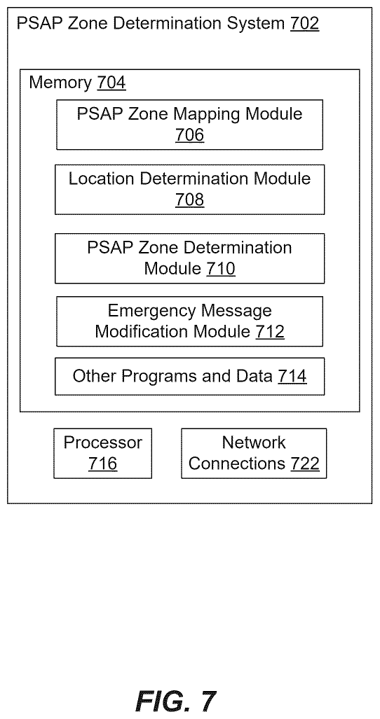

FIG. 7 shows a system diagram that describe various implementations of a computing system 702 for implementing embodiments described herein. System 702 may be referred to as a PSAP zone determination system. In various embodiments, the PSAP zone determination system 702 may be implemented by or within non-terrestrial network satellite 128, feeder-link system 116, wireless network core system 104, or some combination thereof, as discussed herein.

The PSAP zone determination system 702 is a computing system or environment that receives an emergency message originated by a user device and transmitted via a non-terrestrial network satellite, determines in which PSAP zone the user device is located, and modifies the emergency message to include a unique identifier of the PSAP zone, as described herein. In various embodiments, the PSAP zone determination system 702 may also generate mappings between a plurality of PSAP zones and their correspondingly assigned unique identifiers, as described herein. One or more special-purpose computing systems may be used to implement the PSAP zone determination system 702. Accordingly, various embodiments described herein may be implemented in software, hardware, firmware, or in some combination thereof. The PSAP zone determination system 702 includes memory 704, processor 716 and network connections 722.

Processor 716 includes one or more processors, one or more processing units, programmable logic, circuitry, or one or more other computing components that are configured to perform embodiments described herein or to execute computer instructions to perform embodiments described herein. In some embodiments, a processor system may include a single processor 716 that operates individually to perform actions. In other embodiments, a processor system may include a plurality of processors 716 that operate to collectively perform actions, such that one or more processors 716 may operate to perform some, but not all, of such actions. Reference herein to “a processor system” refers to one or more processors 716 that individually or collectively perform actions. And reference herein to “the processor system” refers to 1) a subset or all of the one or more processors 716 comprised by “a processor system” and 2) any combination of the one or more processors 716 comprised by “a processor system” and one or more other processors 716.

Memory 704 may include one or more various types of non-volatile and/or volatile storage technologies. Examples of memory 704 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 704 may be utilized to store information, including computer-readable instructions that are utilized by processor 716 to perform actions, including embodiments described herein.

Memory 704 may have stored thereon PSAP zone Mapping module 706, location determination module 708, PSAP zone determination module 710, and emergency message modification module 712. The PSAP zone mapping module 706 may be configured to generate mappings between PSAP zones and unique identifiers, as described herein. The location determination module 708 may be configured to determine the location of the user device that transmitted an emergency message, as described herein. The PSAP zone determination module 710 may be configured to determine in which PSAP zone the user device is located, as described herein. And the emergency message modification module 712 may be configured to modify the emergency message to include the unique identifier of the PSAP zone in which the user device is located, as described herein. Memory 704 may also store other programs and data 714 (e.g., operating systems, PSAP zone mappings, user device data, etc.).

Although the PSAP zone mapping module 706, the location determination module 708, the PSAP zone determination module 710, and the emergency message modification module 712 are illustrated as separate modules, embodiments are not so limited. Rather, a single module, or a plurality of modules, may be employed to perform the functionality of the PSAP zone Mapping module 706, the location determination module 708, the PSAP zone determination module 710, and the emergency message modification module 712. Moreover, the functionality of the PSAP zone mapping module 706, the location determination module 708, the PSAP zone determination module 710, and the emergency message modification module 712 may be performed by one or more systems or components described herein (e.g., non-terrestrial network satellite 128, feeder-link system 116, wireless network core system 104, etc.).

Network connections 722 are configured to communicate with other computing devices, such as user devices 124a-124c, TCC 410, non-terrestrial network satellite 128, feeder-link system 116, terrestrial network cells 112, etc. In various embodiments, the network connections 722 may include transmitters and receivers (not illustrated) to send and receive data as described herein.

The PSAP zone determination system 702 may also include I/O interfaces, other computer-readable media, or other components not illustrated herein. I/O interfaces may include one or more data input or output interfaces, video or display interfaces, or other input/output interfaces. And other computer-readable media may include other types of stationary or removable computer-readable media, such as removable flash drives, external hard drives, or the like.

The following is a summarization of the original claims as filed.

A method may be summarized as comprising: determining a total geographical coverage area for a public safety answering point (PSAP); dividing the total geographical coverage area for the PSAP into one or more PSAP zones for non-terrestrial network emergency communications; assigning a unique identifier to each corresponding PSAP zone of the one or more PSAP zones; receiving an emergency message from a user device via a non-terrestrial network satellite; determining a geographical location of the user device; determining a PSAP zone from the one or more PSAP zones that corresponds to the geographical location of the user device; determining the unique identifier assigned to the determined PSAP zone; modifying the emergency message to include the determined unique identifier; and outputting the modified emergency message.

The method may further comprise: storing mappings between each corresponding PSAP zone its assigned unique identifier.

The method may determine the PSAP zone from the one or more PSAP zones that corresponds to the geographical location of the user device by: comparing the geographical location of the user device to a geographical area of each corresponding PSAP zone; and selecting the PSAP zone have the geographical area in which the geographical location of the user device is located.

The method may output the modified emergency message including: forwarding the modified emergency message towards an emergency control center to determine which PSAP to associate with the emergency message.

The method may receive the emergency message from the user device including: receiving a text-based emergency message from the user device via the non-terrestrial network satellite.

The method may receive the emergency message from the user device including: receiving a voice-based emergency call from the user device via the non-terrestrial network satellite.

The method may receive the emergency message from the user device including: receiving a real-time-text-based emergency message from the user device via the non-terrestrial network satellite.

The method may determine the geographical location of the user device including: obtaining the geographical location of the user device from the emergency message itself.

A computing system may be summarized as comprising: a memory configured to store computer instructions; and a processor system configured to execute the computer instructions to: receive an emergency message from a user device via a non-terrestrial network satellite of a wireless network; determine a geographical location of the user device; determine an emergency zone from a plurality of emergency zones that corresponds to the geographical location of the user device, wherein the plurality of emergency zones aggregate to make up a total geographical coverage area of a plurality of emergency services; determine a unique identifier assigned to the determined emergency zone; modify the emergency message to include the unique identifier; and output the modified emergency message.

The processor system may be configured to further execute the computer instructions to: determine a corresponding geographical coverage area for each emergency service of the plurality of emergency services; divide each corresponding geographical coverage area into one or more emergency zones for non-terrestrial network emergency communications; and assign a corresponding unique identifier to each corresponding emergency zone.

The processor system may be configured to further execute the computer instructions to: store mappings between each corresponding emergency zone its assigned corresponding unique identifier.

The processor system may determine the emergency zone from the plurality of emergency zones that corresponds to the geographical location of the user device by being configured to further execute the computer instructions to: compare the geographical location of the user device to a geographical area of the plurality of emergency zones; and select the emergency zone have the geographical area in which the geographical location of the user device is located.

The processor system may output the modified emergency message by being configured to further execute the computer instructions to: forward the modified emergency message towards an emergency control center to determine which emergency services to associate with the emergency message.

The processor system may output the modified emergency message by being configured to further execute the computer instructions to: forward the modified emergency message towards an emergency control center to identify a public safety answering point (PSAP) for the emergency message.

The processor system may receive the emergency message from the user device by being configured to further execute the computer instructions to: receive a text-based emergency message from the user device via the non-terrestrial network satellite.

The processor system may receive the emergency message from the user device by being configured to further execute the computer instructions to: receive a voice-based emergency call from the user device via the non-terrestrial network satellite.

The processor system may receive the emergency message from the user device by being configured to further execute the computer instructions to: receive a real-time-text-based emergency message from the user device via the non-terrestrial network satellite.

The processor system may determine the geographical location of the user device by being configured to further execute the computer instructions to: obtain the geographical location of the user device from the emergency message itself.

A non-transitory computer-readable medium may be summarized as storing computer instructions that, when executed by at least one processor, cause the at least one processor to perform actions, the actions comprising: storing mappings between each corresponding emergency zone of a plurality of emergency zones for a plurality of emergency service areas and correspondingly assigned unique identifiers; receiving an emergency message from a user device via a non-terrestrial network satellite; determining an emergency zone from the plurality of emergency zones that corresponds to a geographical location of the user device; determining the unique identifier assigned to the determined emergency zone based on the stored mappings; modifying the emergency message to include the determined unique identifier; and outputting the modified emergency message.

The computer instructions, when executed by the at least one processor to store the mappings, may cause the at least one processor to perform further actions, the further actions comprising: determining a corresponding geographical coverage area for each of the plurality of emergency service areas; divide each corresponding geographical coverage area into the plurality of emergency zones for non-terrestrial network emergency communications; and assigning a corresponding unique identifier to each corresponding emergency zone.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
determining a total geographical coverage area for a public safety answering point (PSAP);
dividing the total geographical coverage area for the PSAP into one or more PSAP zones for non-terrestrial network emergency communications;
assigning a unique identifier to each corresponding PSAP zone of the one or more PSAP zones;
receiving an emergency message from a user device via a non-terrestrial network satellite;
determining a geographical location of the user device;
determining a PSAP zone from the one or more PSAP zones that corresponds to the geographical location of the user device;
determining the unique identifier assigned to the determined PSAP zone;
modifying the emergency message to include the determined unique identifier; and
outputting the modified emergency message.

2. The method of claim 1, further comprising:
storing mappings between each corresponding PSAP zone its assigned unique identifier.

3. The method of claim 1, wherein determining the PSAP zone from the one or more PSAP zones that corresponds to the geographical location of the user device comprises:
comparing the geographical location of the user device to a geographical area of each corresponding PSAP zone; and
selecting the PSAP zone have the geographical area in which the geographical location of the user device is located.

4. The method of claim 1, wherein outputting the modified emergency message comprises:
forwarding the modified emergency message towards an emergency control center to determine which PSAP to associate with the emergency message.

5. The method of claim 1, wherein receiving the emergency message from the user device comprises:
receiving a text-based emergency message from the user device via the non-terrestrial network satellite.

6. The method of claim 1, wherein receiving the emergency message from the user device comprises:
receiving a voice-based emergency call from the user device via the non-terrestrial network satellite.

7. The method of claim 1, wherein receiving the emergency message from the user device comprises:
receiving a real-time-text-based emergency message from the user device via the non-terrestrial network satellite.

8. The method of claim 1, wherein determining the geographical location of the user device comprises:
obtaining the geographical location of the user device from the emergency message itself.

9. A computing system, comprising:
a memory configured to store computer instructions; and
a processor system configured to execute the computer instructions to:
receive an emergency message from a user device via a non-terrestrial network satellite of a wireless network;
determine a geographical location of the user device;
determine an emergency zone from a plurality of emergency zones that corresponds to the geographical location of the user device, wherein the plurality of emergency zones aggregate to make up a total geographical coverage area of a plurality of emergency services;
determine a unique identifier assigned to the determined emergency zone;
modify the emergency message to include the unique identifier; and
output the modified emergency message.

10. The computing system of claim 9, wherein the processor system is configured to further execute the computer instructions to:
determine a corresponding geographical coverage area for each emergency service of the plurality of emergency services;
divide each corresponding geographical coverage area into one or more emergency zones for non-terrestrial network emergency communications; and
assign a corresponding unique identifier to each corresponding emergency zone.

11. The computing system of claim 10, wherein the processor system is configured to further execute the computer instructions to:
store mappings between each corresponding emergency zone its assigned corresponding unique identifier.

12. The computing system of claim 9, wherein the processor system determines the emergency zone from the plurality of emergency zones that corresponds to the geographical location of the user device by being configured to further execute the computer instructions to:
compare the geographical location of the user device to a geographical area of the plurality of emergency zones; and
select the emergency zone have the geographical area in which the geographical location of the user device is located.

13. The computing system of claim 9, wherein the processor system outputs the modified emergency message by being configured to further execute the computer instructions to:
forward the modified emergency message towards an emergency control center to determine which emergency services to associate with the emergency message.

14. The computing system of claim 9, wherein the processor system outputs the modified emergency message by being configured to further execute the computer instructions to:
forward the modified emergency message towards an emergency control center to identify a public safety answering point (PSAP) for the emergency message.

15. The computing system of claim 9, wherein the processor system receives the emergency message from the user device by being configured to further execute the computer instructions to:
receive a text-based emergency message from the user device via the non-terrestrial network satellite.

16. The computing system of claim 9, wherein the processor system receives the emergency message from the user device by being configured to further execute the computer instructions to:
receive a voice-based emergency call from the user device via the non-terrestrial network satellite.

17. The computing system of claim 9, wherein the processor system receives the emergency message from the user device by being configured to further execute the computer instructions to:
receive a real-time-text-based emergency message from the user device via the non-terrestrial network satellite.

18. The computing system of claim 9, wherein the processor system determines the geographical location of the user device by being configured to further execute the computer instructions to:
obtain the geographical location of the user device from the emergency message itself.

19. A non-transitory computer-readable medium storing computer instructions that, when executed by at least one processor, cause the at least one processor to perform actions, the actions comprising:
storing mappings between each corresponding emergency zone of a plurality of emergency zones for a plurality of emergency service areas and correspondingly assigned unique identifiers;
receiving an emergency message from a user device via a non-terrestrial network satellite;
determining an emergency zone from the plurality of emergency zones that corresponds to a geographical location of the user device;
determining the unique identifier assigned to the determined emergency zone based on the stored mappings;
modifying the emergency message to include the determined unique identifier; and
outputting the modified emergency message.

20. The non-transitory computer-readable medium of claim 19, wherein the computer instructions, when executed by the at least one processor to store the mappings, cause the at least one processor to perform further actions, the further actions comprising:
determining a corresponding geographical coverage area for each of the plurality of emergency service areas;
divide each corresponding geographical coverage area into the plurality of emergency zones for non-terrestrial network emergency communications; and
assigning a corresponding unique identifier to each corresponding emergency zone.
